(19) United States
(12) Patent Application Publication
(10) Pub. No.: US 2005/0125697 A1
(43) Pub. Date: Jun. 9, 2005

(54) Device for checking firewall policy

(75) Inventor: Satoshi Tahara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/030,400

(22) Filed: Jan. 7, 2005

Related U.S. Application Data
(63) Continuation of application No. PCT/JP02/13824, filed on Dec. 27, 2002.

(51) Int. Cl. H04L 9/00

(52) U.S. Cl. 713/201

(57) ABSTRACT

An emulation unit establishes a virtual network equivalent to a network to be managed by a firewall device based on network configuration information. A check performing unit gives an instruction to verify the policies set in the firewall device to the emulation unit. The emulation unit transmits a packet to the firewall device based on the given instruction through a connection unit. The check performing unit verifies the policies set in the firewall device based on the response from the firewall device.

### CROSS REFERENCE TO RELATED APPLICATION

This application is a continuation of an international PCT application No. PCT/JP02/13824, which was filed on Dec. 27, 2002.

### BACKGROUND OF THE INVENTION

1. Field of the Invention

The present invention relates to a device, method, and program for checking if firewall policies are properly set.

2. Description of the Related Art

In these years, with the increase in the number of terminals connected to networks, all kinds of information communicated through networks and servers connected to the networks can be accessed by many unspecified users. Because of this, firewalls are increasingly built in networks in order to allow pre-specified accesses or deny non pre-specified accesses.

In a firewall, policies (security policies) have been preset as described in the Japanese Patent Laid-Open No. 2001-358717, for example. This “policy” is information describing what type of access should be allowed or denied including, for example, source addresses, destination addresses, source port numbers, and destination port numbers to be allowed or denied. When a firewall device detects a packet attempting to pass through the firewall, it examines whether the packet satisfies policies preset for it. At this time, if the packet satisfies the policies it is transferred to its destination address. If the packet does not satisfy the policies it is denied, i.e. the packet cannot pass through the firewall.

Thus, the firewall device determines whether to allow or deny access based on preset policies. Therefore, unless policies are correctly set, accesses to be allowed may be denied and vice versa. This makes it necessary to check the setting of firewall policies before starting the operation of a network.

The checking of firewall policies is typically done by communicating messages between the server and the IP host connected to a network via its firewall after the network is built. That is to say, this task is carried out manually.

However, this method makes it difficult to correct bugs in the firewall at an early stage, because the policies cannot be checked until the network is actually built. Also, as the network to be managed grows in size the number of communication paths to be allowed or denied increases enormously, thus making it substantially impossible to check for all the access patterns manually.

Alternatively, a port scanning tool can be used for this check, wherein a SYN message is sent to each IP address while specifying various IP addresses in sequence as destination addresses and it is checked whether policies are properly set based on the response to the message. This type of port scanning tool is known as an IP layer network tester or an Internet test tool, the information on this technology being available at the following site:
http://www.nyankosensei.com/winprg/sub.shtml

In this method, however, it is impossible to perform the checking from other than actually set IP addresses. That is, the checking from any desired address is substantially impossible. Besides, if an IP host does not exist at the destination IP address a response message will not be returned, in which case the check cannot be made. For UDP communications, a destination terminal typically does not return a response message, making it impossible to perform the check. Furthermore, as the number of communication paths to be allowed or denied increases, the time required to check the policies becomes impractically longer.

Thus, the conventional checking methods have various problems. Although studies on the method of setting firewall policies are widely made, the method of checking for correct setting of policies is rarely studied and currently the check is done manually after building a network, as mentioned above. Therefore, no document was found on the method of checking for correct setting of firewall policies, though those on the policy setting method are available abundantly.

### SUMMARY OF THE INVENTION

An object of the present invention is to provide a method whereby firewall policy can be checked before building an actual network. Another object of the present invention is to provide a method whereby checking for correct setting of firewall policy can be made with certain degree of accuracy even when the number of communication paths to be allowed or denied is enormous. A still another object of the present invention is to provide a method whereby firewall policy can be checked in a network employing any communication protocol.

A policy checking device of the present invention is a device for checking whether policy is properly set in a firewall device, comprising: a configuration information storage unit for storing network configuration information describing a configuration of a network to be managed by said firewall device; a policy information storage unit for storing policy information describing a policy to be enforced by said firewall device; an emulation unit for establishing a virtual network based on the network configuration information and transmitting a packet using the virtual network; a connection unit for connecting the virtual network and said firewall device; and a check performing unit for verifying whether the action of said firewall device is in accordance with the policy information by monitoring the packet transmitted by said emulation unit.

According to the present invention, the policy of a firewall device can be checked before a network is actually built, since a virtual network equivalent to the actual network to be managed by a firewall device is established and the policies of the firewall device are checked using the virtual network. Also, when a packet is sent to a firewall device using the virtual network, it is possible to check the policy of the firewall device even if a destination terminal employs a communication protocol that does not return a response message, because the destination of the packet exists in the policy checking device.

A policy checking device of another aspect of the present invention is a device for checking whether a policy including a condition and a result is properly set in a firewall device, comprising: a detection unit for detecting a singular point condition in the policy to be enforced by said firewall device; a selection unit for selecting predetermined number of ordinary area (sampling area) conditions other than the singular point condition from the policy to be enforced by said firewall device; and a verification unit for verifying whether or not results corresponding to the singular point condition and the ordinary area conditions can be obtained by said firewall device.

According to this invention, the time required for policy checking can be shortened, because policy check is not made for all the patterns on which a firewall device determines whether to allow or deny but only for predetermined number of conditions. At this time, since check is made for singular point condition among the conditions consisting policy, most of policy setting errors or description errors are detected. In addition, increasing the frequency of checks for the ordinary area conditions allows statistically calculating the probability that no policy setting error or description error exist.

Other and further objects, features and advantages of the invention will appear more fully from the following description.

### BRIEF DESCRIPTION OF THE DRAWINGS

FIG. 1 is a diagram showing the configuration of a network to be managed by a firewall device;

FIG. 2 is a diagram showing the connection between a firewall device and a policy checking device;

FIG. 3 is a diagram showing the configuration of a network implemented by simplifying the network shown in FIG. 1;

FIG. 4 is a diagram showing the simplified network in FIG. 3 emulated by a policy checking device;

FIG. 5 is a diagram showing a policy checking device.

FIGS. 6A through 6C are embodiments of network configuration information;

FIG. 7 is an embodiment of policy information;

FIG. 8 is a flowchart showing the operation of a policy checking device;

FIG. 9 is a schematic diagram showing how the policy checking is performed by a policy checking device;

FIG. 10 is a flowchart showing the policy check processing;

FIG. 11 is an example of the extracted policy statement;

FIG. 12 is a diagram showing how a singular point and other selection points are determined;

FIGS. 13A through 13E show the extraction of addresses and port numbers of singular point and points in sampling area;

FIG. 14 is a flowchart showing the extraction of addresses and port numbers to be checked from policy information;

FIG. 15 is a block diagram showing a computer that executes a program describing the functions of the present invention; and

FIG. 16 is a diagram showing the installment of a program relating to the present invention.

### DESCRIPTION OF THE PREFERRED EMBODIMENTS

Embodiments of the present invention will be described below with reference to the accompanying drawings.

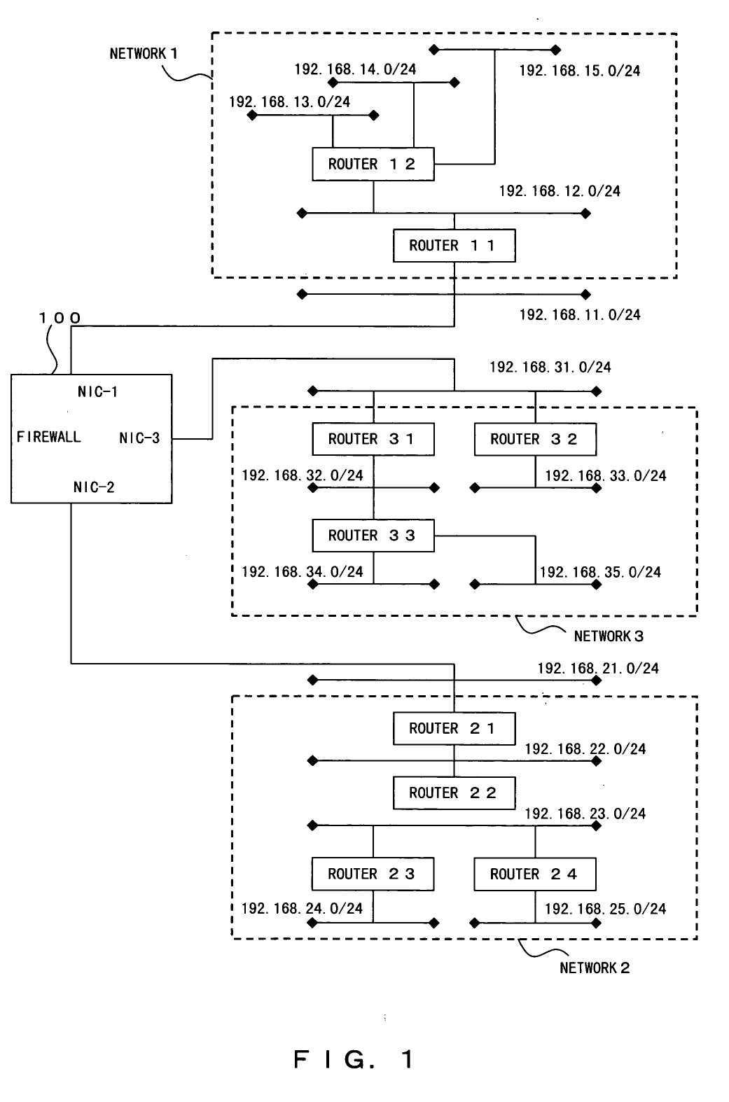

FIG. 1 is a diagram showing the configuration of a network to be managed by a firewall device. This network consists of networks 1 to 3 connected to each other through a firewall device 100.

The network 1 includes routers 11 and 12 and is connected to the firewall device 100 through the router 11. The firewall device 100 and the router 11 are connected via a subnet to which 192.168.11.0/24 is assigned. The “192.168.11.0/24” indicates that addresses 192.168.11.0 through 192.168.11.255 are assigned as IP addresses. The I/O port NIC-1 of the firewall device 100 is connected to this subnet and is assigned an IP address 192.168.11.1. The network 1 includes four subnets to which IP addresses 192.168.12.0/24, 192.168.13.0/24, 192.168.14.0/24, and 192.168.15.0/24 are assigned respectively.

Likewise, the network 2 includes routers 21, 22, 23, and 24 and is connected to the firewall device 100 through the router 21. The firewall device 100 and the router 21 are connected via a subnet to which 192.168.21.0/24 is assigned. The I/O port NIC-2 of the firewall device 100 is connected to this subnet and is assigned an IP address 192.168.21.1. The network 2 includes four subnets to which IP addresses 192.168.22.0/24, 192.168.23.0/24, 192.168.24.0/24, and 192.168.25.0/24 are assigned respectively.

The network 3 includes router 31, 32, and 33 and is connected to the firewall device 100 through the routers 31 and 32. The firewall device 100 is connected to the routers 31 and 32 through a subnet to which 192.168.31.0/24 is assigned. The I/O port NIC-3 of the firewall device 100 is connected to this subnet and is assigned an IP address 192.168.31.1. The network 3 includes four subnets to which IP addresses 192.168.32.0/24, 192.168.33.0/24, 192.168.34.0/24, and 192.168.35.0/24 are assigned respectively.

In the above network system, security policies that restrict the access or packet transfer between the network 1, 2, and 3 are set in the firewall device 100. Accordingly, when the firewall device 100 receives a packet attempting to pass through the firewall, it allows or denies the packet based on the policies.

A policy checking device according to the present invention checks whether or not the policies are properly set in a firewall device (the firewall 100 in FIG. 1). The policy checking device, however, can check the policies set in the firewall device before a network (the networks 1 to 3 in FIG. 1) is actually built.

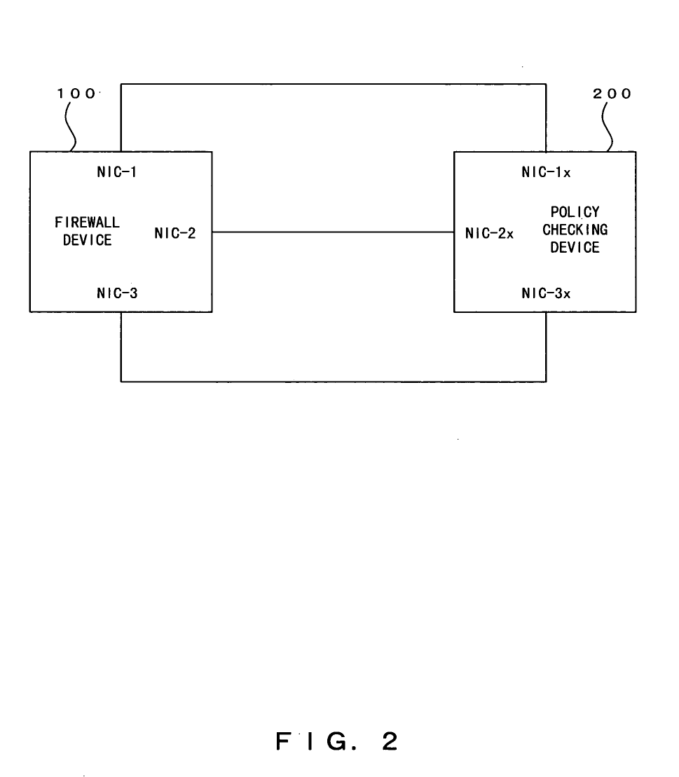

FIG. 2 is a block diagram showing the connection between a firewall device and a policy checking device. A policy checking device 200 has a plurality of I/O ports (NIC-1x to NIC-3x) and is connected to the firewall device 100 through these ports. In the example of FIG. 1, the firewall device 100 is connected to the networks 1 to 3 via ports NIC-1 to NIC-3. The networks 1 to 3 are established as virtual networks in the policy checking device 200, when the policies in the firewall device 100 are checked. Therefore, when the policies in the firewall device 100 are checked, the ports NIC-1 to NIC-3 of the firewall device 100 are connected to the ports NIC-1x to NIC-3x of the policy checking device 200, respectively.

The media (communication method or communication protocols) supported by each I/O port of the policy checking device 200 are the same as those supported by the corresponding I/O port of the firewall device 100. For example, the port NIC-1 of the firewall device 100 and the port NIC-1x of the policy checking device both support a communication method for the subnet to which 192.168.11.0/24 is assigned, such as 100BASE-TX full duplex.

Meanwhile, when determining whether to allow or deny an arrived packet, the firewall device 100 detects the port at which the packet arrived (NIC-1 to NIC-3) and also checks the address and the like of the packet. However, the firewall 100 needs not to know how the packet was routed when making the above determination. This makes possible for the policy checking device 200 to simplify the network configuration when emulating a network to be managed by the firewall device 100.

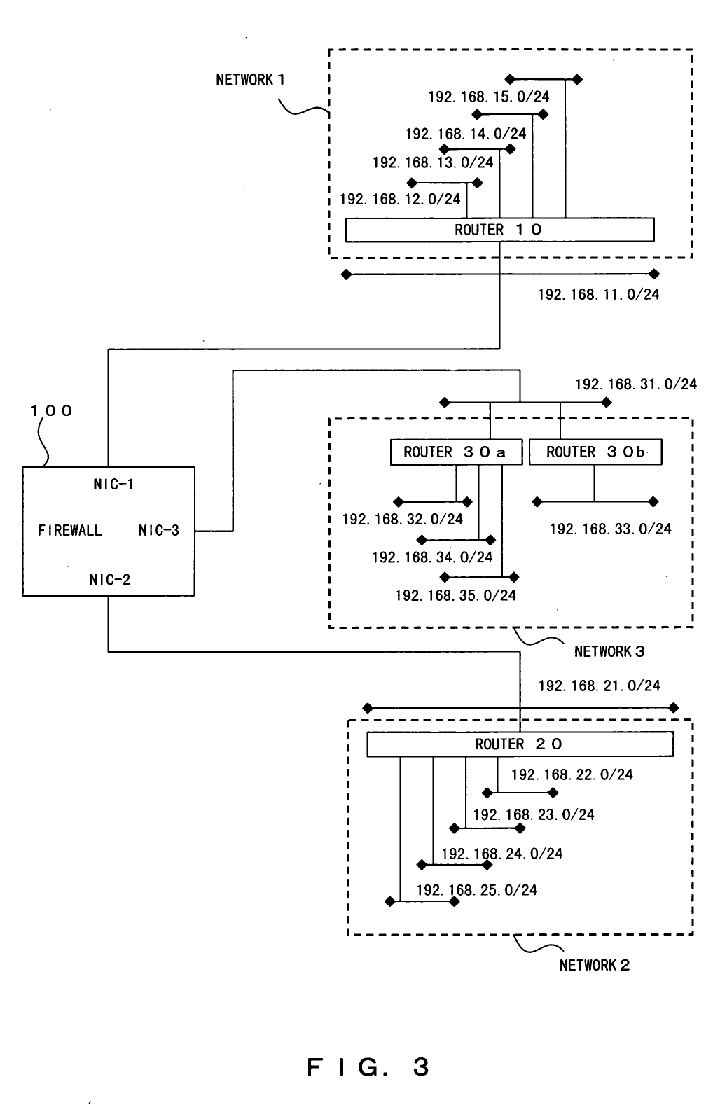

FIG. 3 is a diagram showing the configuration of a network implemented by simplifying the network shown in FIG. 1. In this simplified network, there exists only a router at the first stage as seen from the firewall device 100, routers at the second and subsequent stages being omitted. That is, the network 1 shown in FIG. 1 is represented by a single router (router 10) and four subnets 192.168.12.0/24, 192.168.13.0/24, 192.168.14.0/24, and 192.168.15.0/24 connected to that router.

Likewise, the network 2 shown in FIG. 1 is represented by a single router (router 20) and four subnets 192.168.22.0/24, 192.168.23.0/24, 192.168.24.0/24, and 192.168.25.0/24 connected to that router. Also, the network 3 shown in FIG. 1 is represented by two routers (routers 30a and 30b) and four subnets 192.168.32.0/24, 192.168.33.0/24, 192.168.34.0/24, and 192.168.35.0/24 connected to those routers.

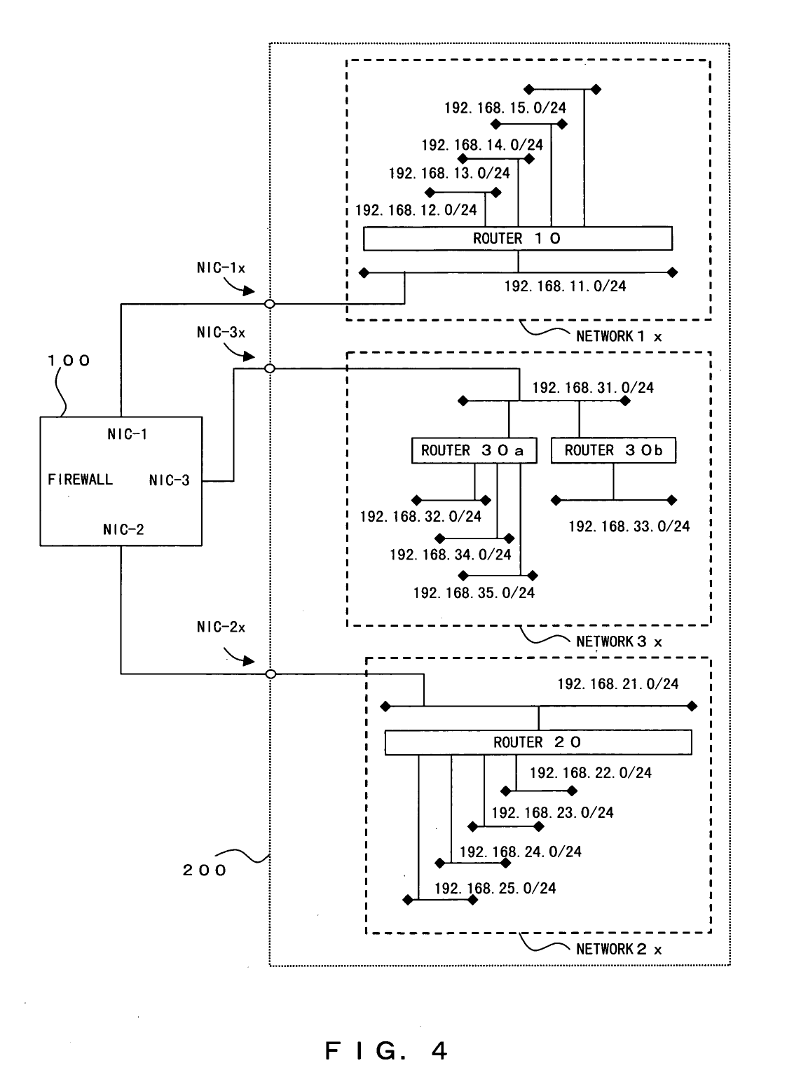

FIG. 4 is a diagram showing the simplified network in FIG. 3 emulated by the policy checking device 200. In FIG. 4, a network 1x is a virtual network created by emulating the simplified network 1 shown in FIG. 3. Since the network 1 is connected to the port NIC-1 of the firewall device 100 as shown in FIGS. 1 and 3, the network 1x established in the policy checking device 200 is connected to the port NIC-1 of the firewall device 100 via the port NIC-1x.

Likewise, a network 2x is a virtual network created by emulating the simplified network 2 shown in FIG. 3 and is connected to the port NIC-2 of the firewall device 100 via the port NIC-2x. Also, a network 3x is a virtual network created by emulating the simplified network 3 shown in FIG. 3 and is connected to the port NIC-3 of the firewall device 100 via the port NIC-3x.

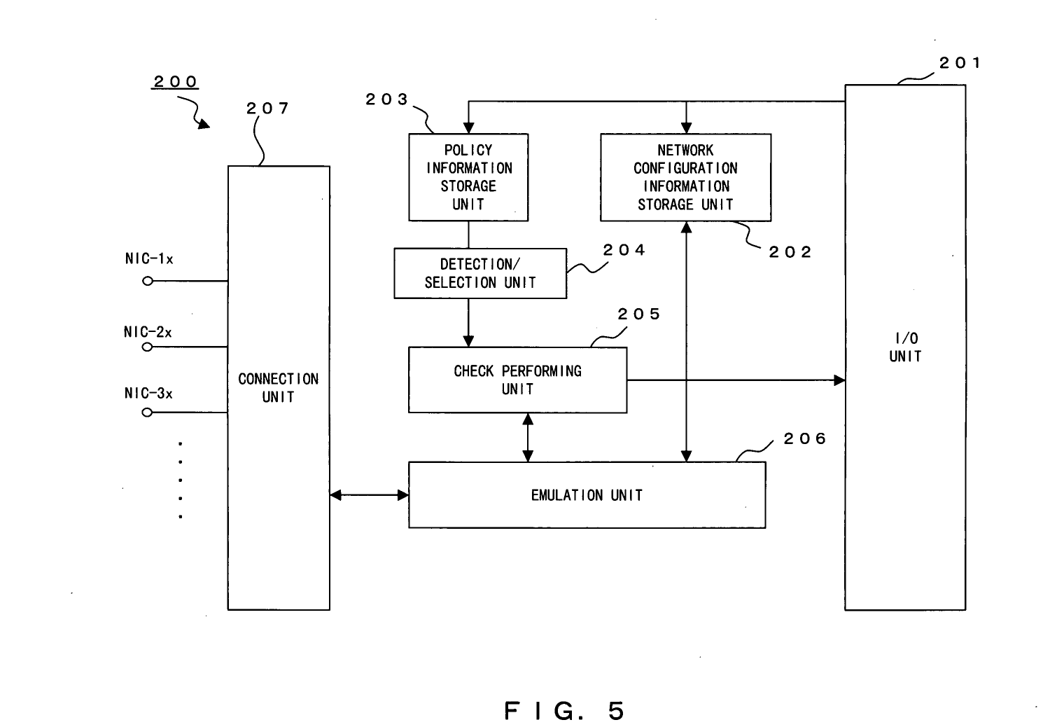

FIG. 5 is a diagram showing the configuration of the policy checking device 200. The policy checking device 200 is implemented by executing a software program previously described using a computer.

An I/O unit 201 provides a user interface such as GUI to accept data from users. Users can input network configuration information, policy information, and media information through this I/O unit 201. These information is described, for example, in CSV format herein. The I/O unit 201 outputs the result of checking of policies in the firewall device 100 to, for example, a display screen or printer.

A network configuration storage unit 202 stores the network configuration information input through the I/O unit 201. The network configuration information is information indicating the configuration of a network to be managed by the firewall device 100.

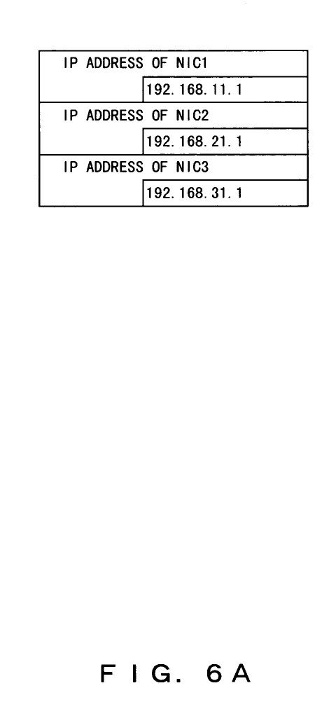

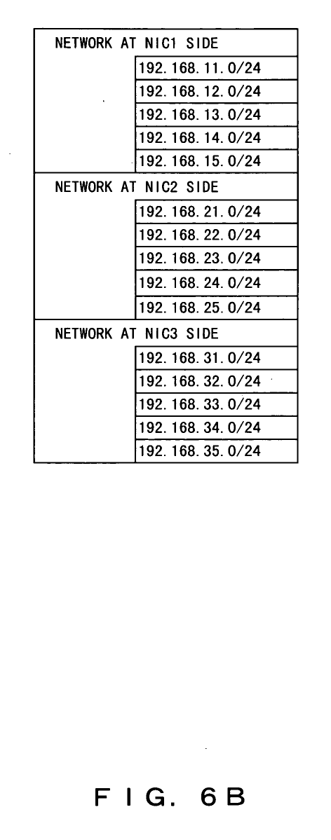

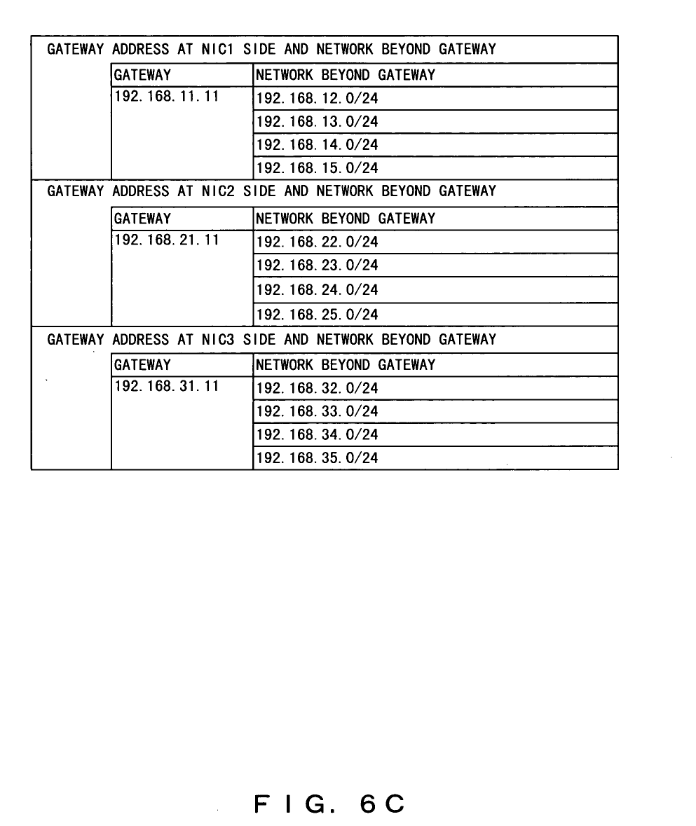

FIGS. 6A through 6C are embodiments of network configuration information. FIG. 6A is an example of information indicating IP addresses for the ports NIC-1 to NIC-3 of the firewall device 100. FIG. 6B is an example of information managing subnets that belong respectively to the networks 1 through 3 to be connected to the firewall device 100. FIG. 6C is an example of information managing subnets that exist at and beyond the gateways to be connected respectively to the ports NIC-1 to NIC-3 of the firewall device 100. The gateways to be connected respectively to ports NIC-1 to NIC-3 of the firewall device 100 is also emulated by the policy checking device 200, and the IP addresses of corresponding gateways are set as the respective IP addresses of the ports NIC-1x to NIC-3x of the policy checking device 200. For the subnets existing beyond each gateway, the information shown in FIG. 6B is used.

A policy information storage unit 203 stores the policy information input through the I/O unit 201. The policy information is information describing the policies to be enforced by the firewall device 100, i.e. the security policies defining the action of the firewall device 100.

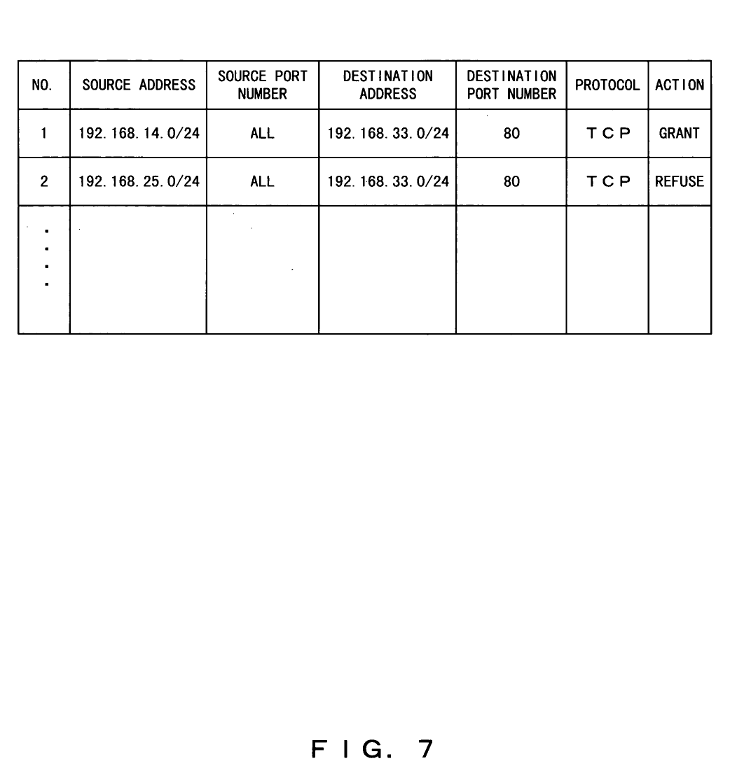

FIG. 7 is an embodiment of policy information. Each policy making up the policy information includes condition section and result section. In this example, the condition section consists of source IP address, source port number, destination IP address, destination port number, and protocol. The “port number” specifies the service of TCP or UDP. The “protocol” identifies a communications protocol such as TCP, UDP, and ICMP. The result section indicates the action (allow or deny) of the firewall device 100 when it received a packed satisfying the conditions described in the condition section.

The policy information to be stored in the policy information storage unit 203 is basically the same as that actually set in the firewall device 100. This policy information, however, is used for confirming that the policy information actually set in the firewall device 100 is properly defined or described as well as for confirming the action of the firewall device 100, and therefore is prepared independent of the policy information actually set in the firewall device 100.

A detection/selection unit 204 extracts a condition to be actually checked from the policy information stored in the policy information storage unit 203. The operation of the detection/selection unit 204 will be described later in detail.

A check performing unit 205 checks the policies set in the firewall device 100 according to the conditions extracted by the detection/selection unit 204. Specifically, the check performing unit 205 instructs an emulation unit 206 to transmit a packet satisfying the conditions extracted by the detection/selection unit 204. The check performing unit 205 checks whether or not the result of the packet transmission by the emulation unit 206 matches the action described in the result section of the policy information, and sends the check result to the I/O unit 201.

An embodiment of the checking steps performed by the check performing unit 205 is shown below.
1. In a case where TCP is used as communications protocol:
(a) In a case where the firewall device 100 allows a transmitted packet;
(1) Check that a SYN, SYNACK, ACK, FIN, RST, and/or data packet can pass through the firewall device 100.
(b) In a case where the firewall device 100 denies a transmitted packet;
(1) Check that a SYN, SYNACK, ACK, FIN, RST, and/or data packet does not pass through the firewall device 100.
(2) Check that the firewall device 100 ignores a SYN, SYNACK, ACK, FIN, RST, and/or data packet.
(3) Check that the firewall device 100 makes a predetermined response when denying a SYN, SYNACK, ACK, FIN, RST and/or data packet.
2. In a case where UDP or ICMP is used as communications protocol:
(a) In a case where the firewall device 100 allows a transmitted packet;
(1) Check that a dummy packet can pass through the firewall device 100.
(b) In a case where the firewall device 100 denies a transmitted packet;
(1) Check that a dummy packet does not pass through the firewall device 100.
(2) Check that a dummy packet is ignored by the firewall device 100.
(3) Check that the firewall device 100 makes a predetermined response when denying a dummy packet.

When checking the policies set in the firewall device 100, it is desirable to use an application actually used in the network to be managed by that firewall device 100. Therefore, the policy checking device 200 preferably has a function of calling and using such an application.

The emulation unit 206 establishes a virtual network corresponding to the network to be managed by the firewall device 100 based on the network configuration information stored in the network configuration information storage unit 201. An embodiment of the virtual network to be established by the emulation unit 206 is as shown in FIG. 5. The emulation unit 206 creates and transmits a packet as instructed by the check performing unit 205.

A connection unit 207 first sets the media for the ports NIC-1x to NIC-3x according to the media information input from the I/O unit 201, and then outputs the packet created by the emulation unit 206 to the firewall device 100 through the ports NIC-1x to NIC-3x. Also, the connection unit 207 passes a packet received from the firewall device 100 through the NIC-1x to NIC-3x to the emulation unit 206.

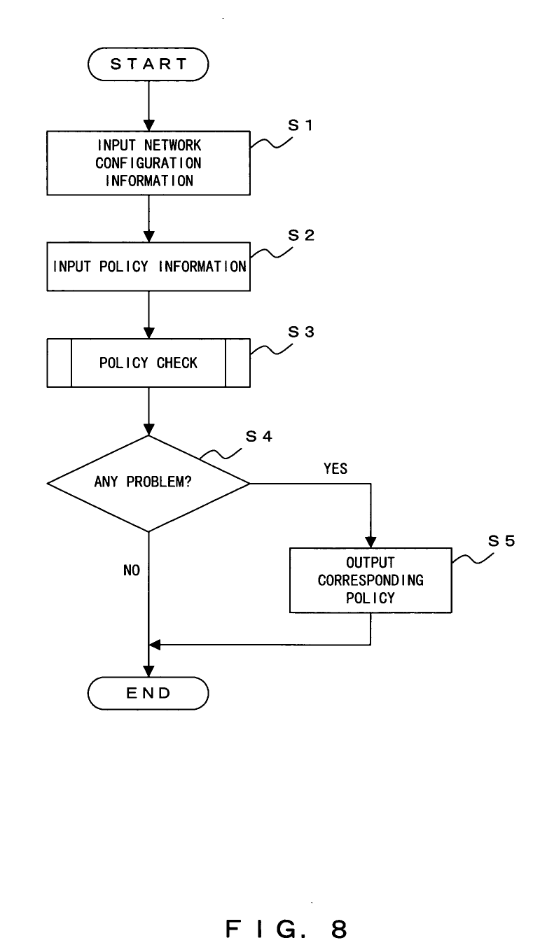

FIG. 8 is a flowchart showing the operation of the policy checking device 200. The processing shown in this flowchart starts, for example, on receipt of the instruction of a user (here, an operator who checks the firewall device 100).

Step S1 stores the network configuration information input by a user through the I/O unit 201 in the network configuration information storage unit 202. An embodiment of the network configuration information is as described with reference to FIGS. 6A to 6C. Step S2 stores the policy information input by a user through the I/O unit 201 in the policy information unit 203. An embodiment of the policy information is as described with reference to FIG. 7.

In steps S3 and S4, the detection/selection unit 204, the check performing unit 205, the emulation unit 206, and the connection unit 207 perform the policy checking processing for the policies set in the firewall device 100. This processing will be described later in detail.

Unless an abnormal operation is detected in steps 3 and 4, the processing is finished. If an abnormal operation is detected, the policy associated with that abnormal operation is informed to the I/O unit 201 in step 5. This results in the user being informed of the policy associated with the abnormal operation that occurred in the firewall device 100.

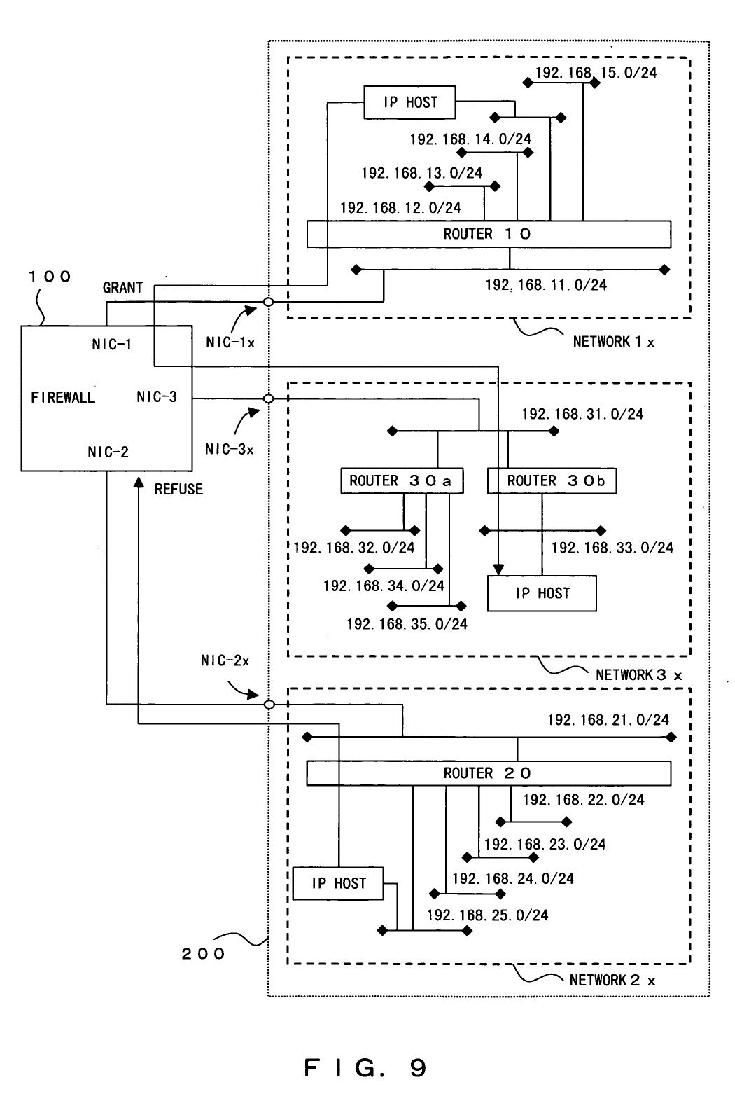

FIG. 9 is a schematic diagram showing how the policy checking device 200 performs the policy check. Shown here is a case where two policies in FIG. 7 are checked.

The first policy shown in FIG. 7 is as follows: “A packet that is transmitted from subnet 192.168.14.0/24 to subnet 192.168.33.0/24 over TCP and whose destination port number is 80 is allowed.”

In this case, the policy checking device 200 creates a packet whose source address is a prescribed IP address in the 192.168.14.0/24 and destination address is a prescribed IP address in the 192.168.33.0/24 and destination port number is set to 80, and transmits the packet from virtual network 1x to virtual network 3x. At this time, the router 10 provided in the virtual network 1x directs the packet to the port NIC-1x according to its destination address, thereby transmitting the packet to the firewall device 100.

On receipt of the packet via NIC-1, the firewall device 100 processes the packet according to the policies actually set therein. If the policies are properly set, the firewall device 100 output the packet via NIC-3. Consequently, the packet is transmitted to the virtual network 3x and then transferred to the source address specified by the router 30b.

The check performing unit 205 in the policy checking device 200 analyses the packet received from the firewall device 100 to check whether or not the policies set in the firewall device 100 is proper. Specifically, it is checked, for example, whether or not the packet transmitted from the virtual network 1x is received through the port NIC-3. This makes it possible to check whether or not the policies relating to “an access from subnet 192.168.14.0/24 to subnet 192.168.33.0/24 over TCP with the destination port number set at 80” are properly set in the firewall device 100.

If the above policies were not properly set in the firewall device 100, for example, a packet transmitted from the virtual network 1x to virtual network 3x as described above would be denied by the firewall device 100 and therefore the policy checking device 200 would not be able to receive that packet.

The second policy shown in FIG. 7 is as follows: “A packet that is transmitted from subnet 192.168.25.0/24 to subnet 192.168.33.0/24 over TCP and whose destination port number is 80 is denied”

In this case, the policy checking device 200 creates a packet whose source address is a prescribed IP address in the 192.168.25.0/24 and destination address is a prescribed IP address in the 192.168.33.0/24 and destination port number is set to 80, and transmits it from virtual network 2x to virtual network 3x. At this time, the router 20 provided in the virtual network 2x directs the packet to the port NIC-2x according to its destination address, thereby transmitting the packet to the firewall device 100.

On receipt of the packet via NIC-2, the firewall device 100 processes the packet according to the policies actually set therein. If the policies are properly set, the firewall device 100 denies that packet. Consequently, the packet will not be transferred to the policy checking device 200.

If the packet is not received even after the predetermined time has passed, the check performing unit 205 in the policy checking device 200 judges that the policies set in the firewall device 100 are appropriate. If the policy is not properly set in the firewall device 100, the packet transmitted from the virtual network 2x to virtual network 3x as described above, for example, would pass through the firewall device 100. Consequently, the policy checking device 200 would judge that the policies set in the firewall device 100 are not proper if it receives that packet.

Thus, according to the checking method of the embodiment, a virtual network equivalent to a network to be managed by the firewall device 100 is established and packets can be transferred using that virtual network, making it possible to check the policies set in the firewall device 100 even before building a network actually. Also, in this checking method, it is monitored whether or not a packet transmitted from the policy checking device 200 returns to the policy checking device 200 through the firewall device 100, and therefore it is possible to check the action of the firewall device 100 even with a protocol like UDP that does not return a response message from the source to destination of the packet.

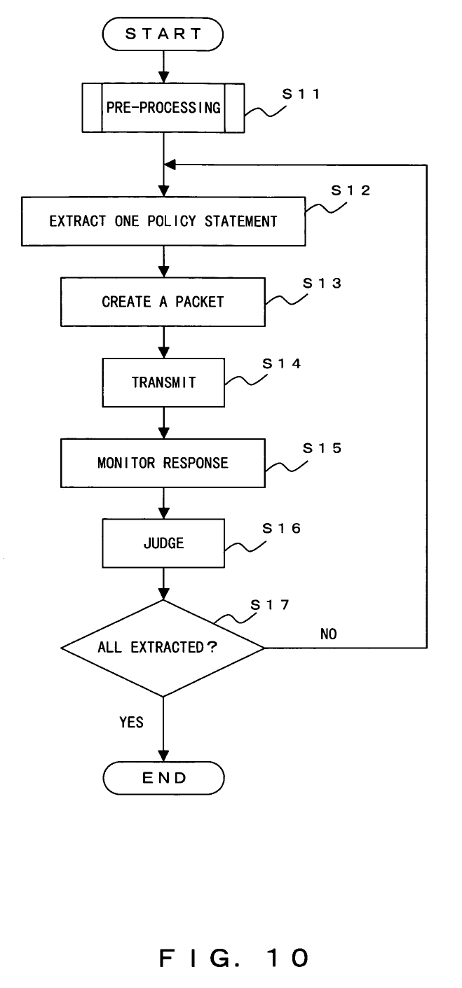

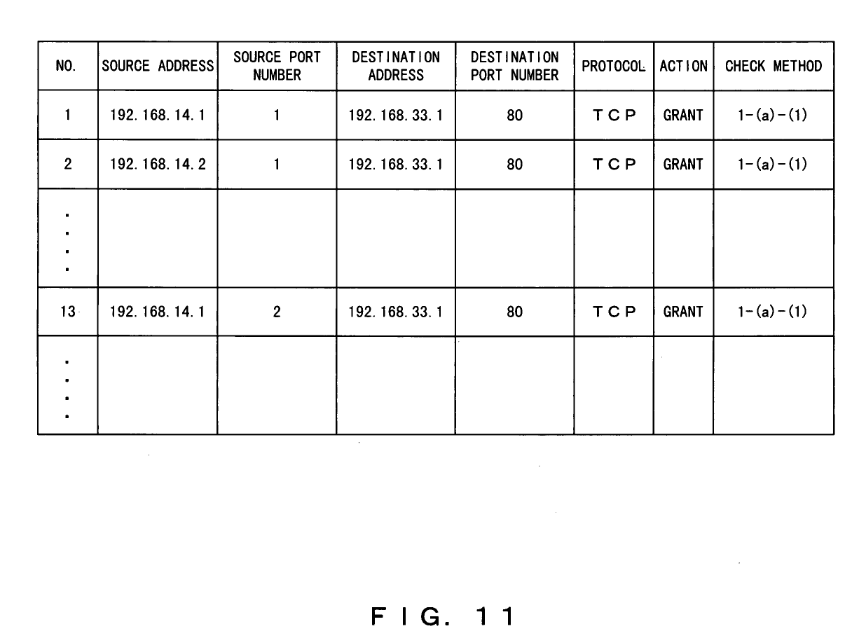

FIG. 10 is the flowchart of the policy checking processing (step S3) in FIG. 8. Step S11 is pre-processing executed by the detection/selection unit 204, wherein predetermine number of policy statements are extracted, based on the previously prepared algorithm, from enormous number of policy statements obtained by breaking down and then combining the policy information stored in the policy storage unit 203 for each address and port number. FIG. 11 shows examples of the policy statements extracted by this processing.

Step S12 extracts one policy statement from a plurality of policy statements obtained by step S11. Step S13 creates a packet corresponding to the extracted policy statement. For example, when the first policy statement shown in FIG. 11 is extracted, a packet with source address set to 192.168.14.1, source port number to 1, destination address to 192.168.33.1, and destination port number to 80 is created. Creating this packet is equivalent to providing a source IP host with IP address 192.168.14.1 in the virtual network 1x and a destination IP host with IP address 192.168.33.1 in the virtual network 3x. That is, in step S13, a virtual network satisfying the conditions of a policy statement is emulated in the policy checking device 200.

Step S14 transmits the packet created in step S13. At this time, a communications protocol specified in the policy statement is used. This packet is transferred to its destination address by a router in the virtual network, i.e. the packet is transferred to the firewall device 100. On receipt of the packet from the policy checking device 200, the firewall device 100 allows or denies the packet according to the policies actually set therein.

Step S15 monitors whether or not the packet transmitted in step S14 returns through the firewall device 100. Then, step S16 determines whether the policies set in the firewall device 100 are normal. Specifically, for example, when a packet to be allowed by the firewall device 100 is transmitted, if the packet is returned through the firewall device 100, the policies are judged to be normal, and if not, abnormal. Likewise, when a packet to be denied by the firewall device 100 is transmitted, if the packet is returned through the firewall device 100, the policies are judged to be abnormal, and if not, normal.

This method is an example of the simplest check and more complicated check is possible. An embodiment of the checking method is as described above. That is, the policies set in the firewall device 100 can be checked for normality by, for example, transmitting a SYN message to be allowed by the firewall device 100 when communications protocol is TCP, and checking whether or not a corresponding ACK message is returned in response to the SYN message.

Step S17 is provided to execute the processing of steps S13 to S16 above for all the policy statements obtained by step S11.

Next, the pre-processing (step S11) in FIG. 10 will be described. This preprocessing is introduced to shorten the time required for policy checking.

Attempting to check firewall policies for every combination of address and port number will require enormous amount of time. For example, the following combinations are required to check the first policy shown in FIG. 7:
Number of source address: 256 (2⁸)
Number of destination address: 256 (2⁸)
Number of source port number: 65536 (2¹⁶)
Number of destination port number: 1
Number of protocol: 1

Therefore, if all the combinations are to be checked, the number of times of checks is calculated as follows:
Number of times of checks=256×256×65536×1×1=4294967269

Assuming the time required for one time of check is 1 ms, total time required to check the above policy will be about 50 days. Furthermore, since a plurality of policies are typically set in the firewall device, it is effectively impossible to check all of them.

Therefore, according to the present invention, check is performed not for all the combinations but for the combinations likely to cause a policy setting error or description error or those in which policy setting errors or description errors are likely to be detected, the other combinations being checked selectively.

To implement this, the present invention introduces the concept of “singular point” for detecting combinations in which policy setting errors or description errors are likely to be detected. The “singular point” is a point where the probability of occurring a policy setting error or description error is not even and indicates a threshold value (or a value close to it) of a policy parameter (address, port number, etc.) at which internal processing of the firewall device changes. Examples of the singular point are as follows:
1. Source address (TCP/UDP/ICMP)
(1) Boundary between private address and global address
(2) Network address
(3) Broadcast address
(4) Multicast address
(5) Boundary between address before the firewall and address beyond it
(6) Same IP address as destination
(7) Destination address after NAT conversion
2. Destination address (TCP/UDP/ICMP)
(1) Boundary between private address and global address
(2) Network address
(3) Broadcast address
(4) Multicast address
(5) Boundary between address before the firewall and address beyond it
(6) Same IP address as source
(7) Source address after NAT conversion 3. Source port number (TCP/IP)
(1) “Start” and “End” of a specified range
(2) “Start±1” and “End±1” of a specified range
(3) “Start” and “End” of a well-known port
(4) “Start±1” and “End±1” of a well-known port
(5) Same port number as destination port
(6) For UDP, equivalent port number for TCP
(7) For TCP, equivalent port number for UDP
4. Destination port number (TCP/UDP)
(1) “Start” and “End” of a specified range
(2) “Star±1” and “End±1” of a specified range
(3) “Start” and “End” of a well-known port
(4) “Start±1” and “End±1” of a well-known port
(5) Same port number as source port
(6) For UDP, equivalent port number for TCP
(7) For TCP, equivalent port number for UDP
5. Source port number (ICMP)
(1) “Start” and “End” of a specified range
(2) “Star±1” and “End±1” of a specified range
(3) Same port number as destination port
6. Destination port number (ICMP)
(1) “Start” and “End” of a specified range
(2) “Star±1” and “End±1” of a specified range
(3) Same port number as source port

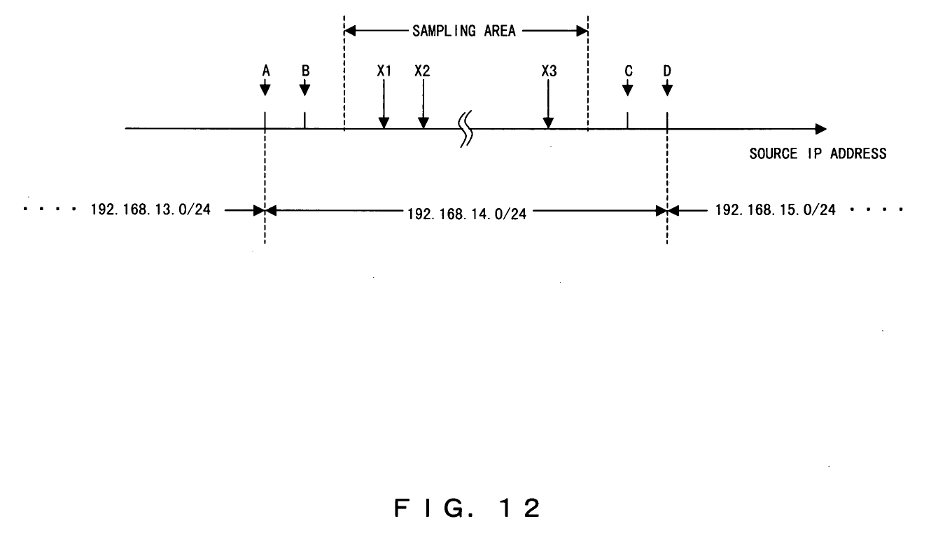

FIG. 12 is a diagram showing how a singular point and other selection points are determined. Here, assume that “source IP address range=192.168.14.0 to 192.168.14.255” is specified as one of the conditions defining a policy. In this case, for example, the following four points are detected as singular points.
Point A: 192.168.14.0 (“Start” of the specified range)
Point B: 192.168.14.1 (“Start+1” of the specified range)
Point C: 192.168.14.254 (“End−1” of the specified range)
Point D: 192.168.14.255 (“End” of the specified range)

The continuous areas (192.168.14.2 to 192.168.14.253) other than singular points in the specified range above are called “sampling area”. From these sampling areas, predetermined number of IP addresses are extracted as source addresses to be checked.

The policy checking device 200 detects singular points for the source address, destination address, source port number, and destination port number set as policies, as described above, and selects predetermined number of addresses or port numbers from each sampling area. Then, policy statements are created based on their combinations.

As described above, the singular point is a point where a policy setting error or description error is likely to be detected. For example, if a source addresses to be allowed are misdescribed as “192.168.14.0 to 192.168.14.155”, not “192.168.14.0 to 192.168.14.255” that are correct addresses, this misdescription can be detected by checking for the “192.168.14.255” (“End” of the specified range) detected as a singular point. Accordingly, it is presumed that even if policy setting errors or misdescriptions exist, most of them can be detected by checking the action of the firewall device for each singular point.

In the sampling area, on the other hand, the probability of occurring policy setting errors or misdescriptions is presumably even. On this assumption, the probability that communications are denied in the sampling area corresponding to a range of source addresses that are allowed to communicate by a policy will be discussed below. Here, it is assumed that communications are allowed by the firewall device at singular points corresponding to the sampling range of source addresses mentioned above.

In this case, if an access from an address (X1) in a sampling area is allowed to communicate by the firewall device but an access from another address (X2) in the sampling area is denied, it is presumably caused by a bug in the software installed in the firewall device or a human-made policy setting error or misdescription. Assume that the probability is “1/10” that communications are denied at address X2 despite the fact that communications are allowed at address X1. However, the probability is presumably extremely low that there is a bug causing the action of the firewall device to become abnormal despite the fact that policies are described correctly.

Therefore, the probability becomes “1/10ⁿ” that “n” addresses among the “n+1” addresses selected from the sampling area are allowed to communicate and the remaining one address is denied. Thus, for example, if ten addresses are selected from a sampling area and checked and the result conforming to the policy is obtained, the probability of causing an action nonconforming to the policy in that sampling area becomes as low as “1/10¹⁰”. Even if the probability is assumed to be “½” that communications are denied at address X2 despite the fact that communications are allowed at address X1 in a sampling area, by selecting ten addresses from the sampling area and checking them the probability that an action nonconforming to the policy in that sampling area becomes a sufficiently low value of 1/1024. Thus, in this embodiment, the number of address and port number to be selected from each sampling area is “10” respectively.

Using singular point and sampling areas as described above will reduce the number of checks. Here, the first policy shown in FIG. 7 will be discussed as in the case where all the combinations of address and port number are checked.

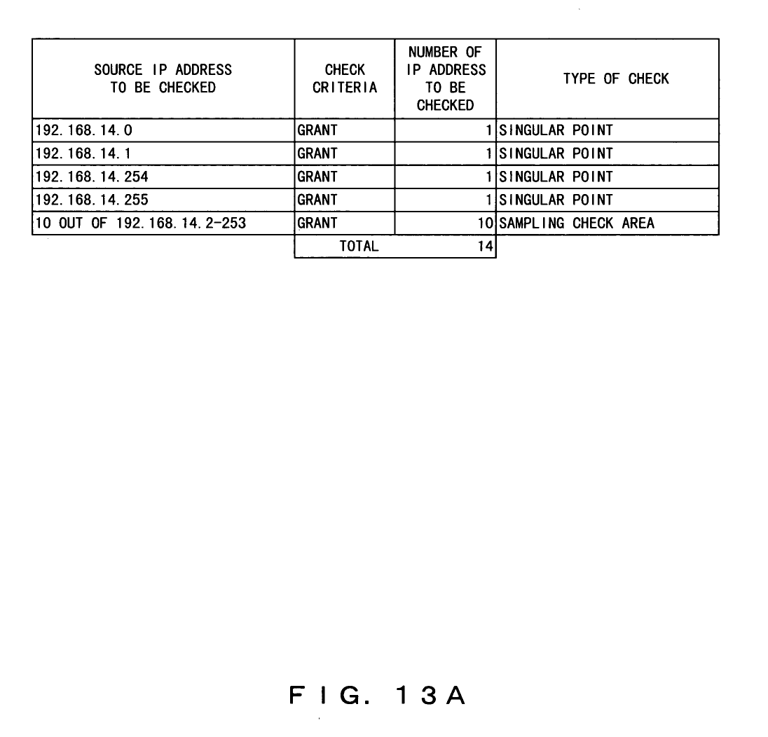

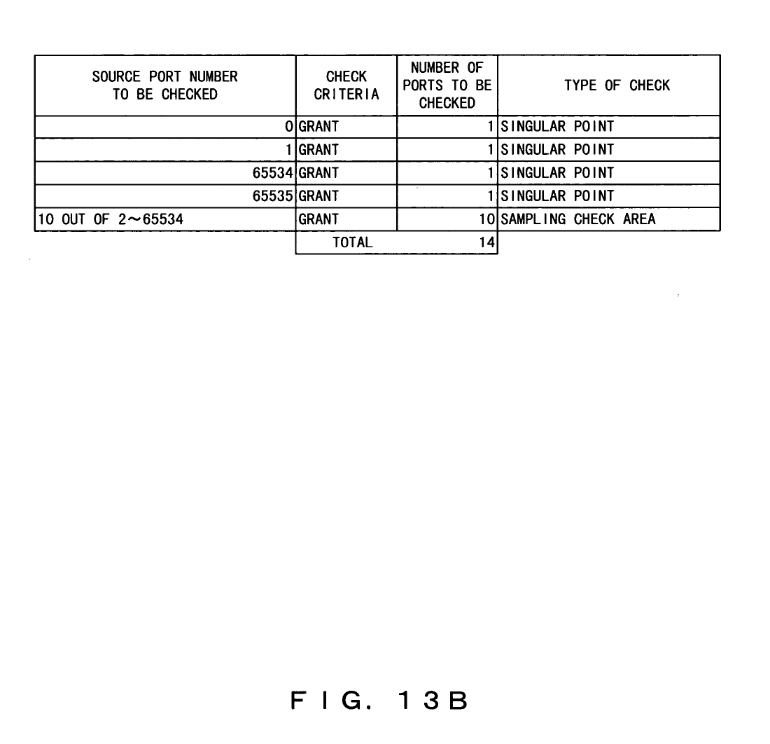

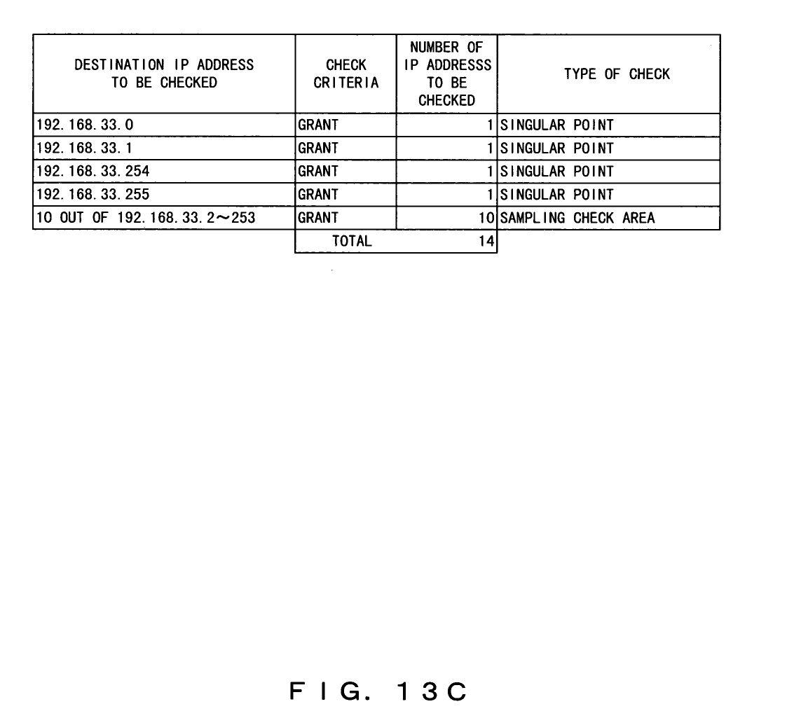

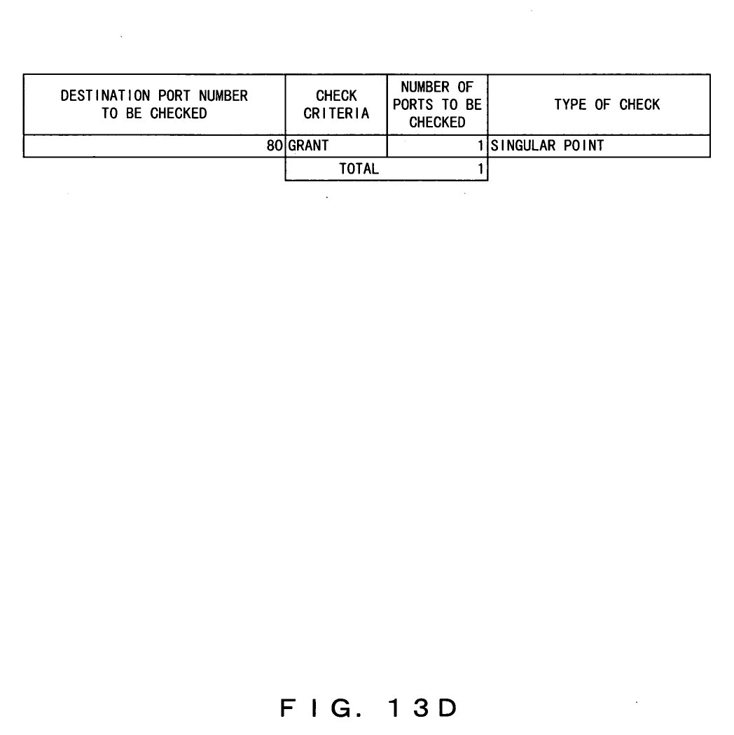

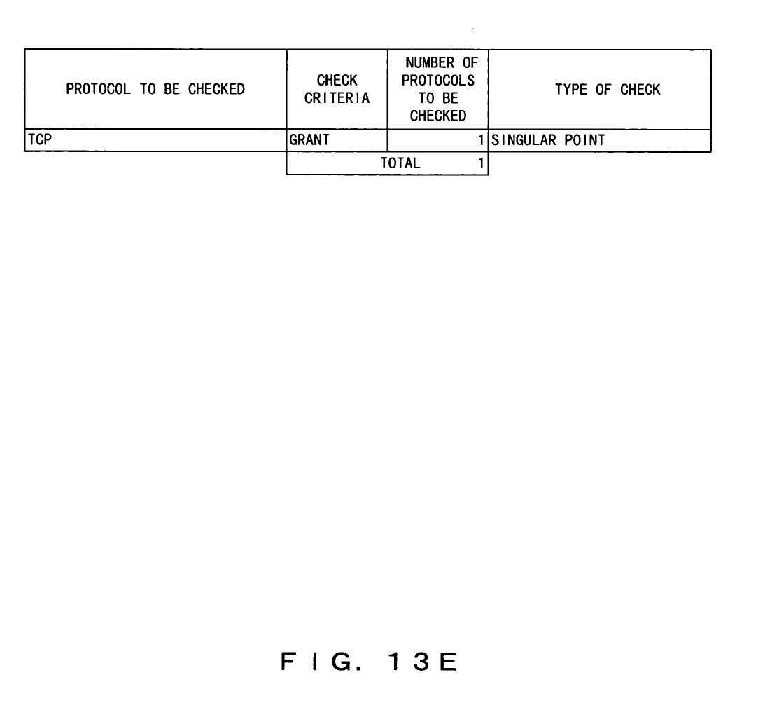

In this case, since four singular point addresses are detected and ten sampling areas are selected as shown in FIG. 13A, a total of 14 addresses are extracted as source addresses for policy checking. Likewise, 14 source port numbers and 14 destination addresses are extracted as shown in FIGS. 13B and 13C. For the destination port number and communications protocol, one port number and one protocol are predetermined, respectively. Therefore, if check is performed for each combination of these extracted address and port number, the number of time of check is calculated as follows:
Number of times of checks=14×14×14×1×1=2744

Assuming the time required for one time of check is 1 ms, total period required to check the above policy will be only 2.744 seconds. That is, according to the checking method of this embodiment, it is possible to perform checks in extremely short period while assuring, with a certain probability, that the policies set in the firewall device is proper.

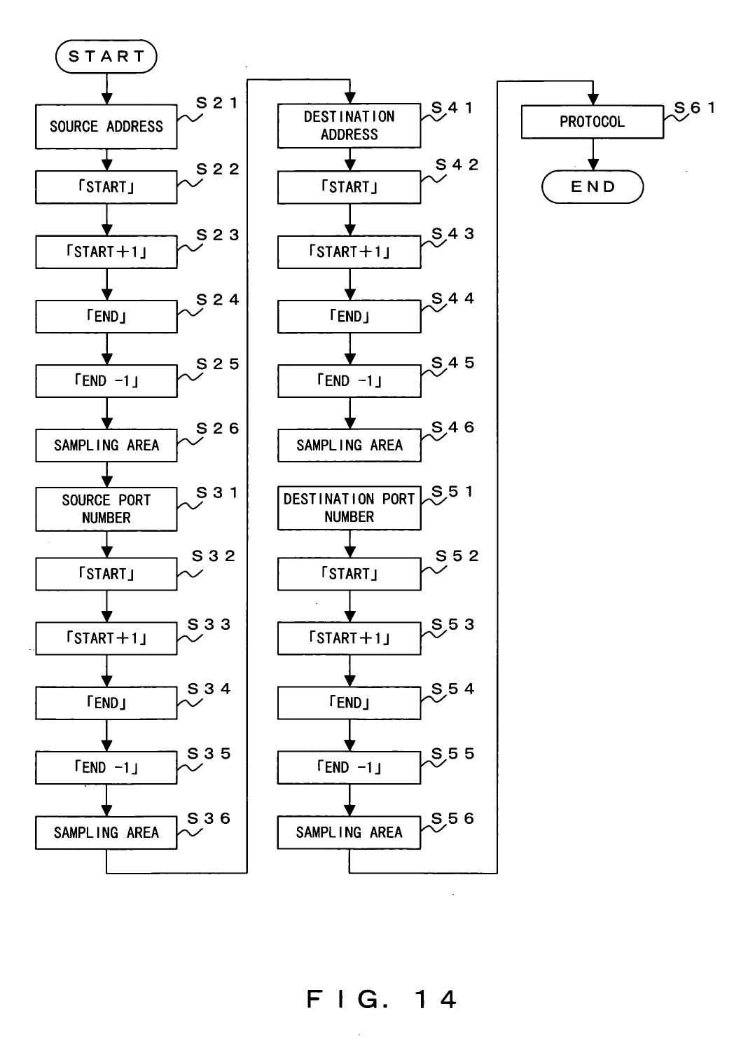

FIG. 14 is the flowchart showing the processing for extracting the addresses and port numbers to be checked based on the policy information and corresponds to the preprocessing (step S11) in FIG. 10. The processing shown in FIG. 14 is to be performed for every policy. Here, for example, assume that the processing for the first policy in FIG. 7 is performed.

Step S21 extracts the information set for the source address from the specified policy information. Specifically, “a range of source addresses=192.168.14.0 to 192.168.14.255” is extracted. Step S22 detects the “Start address” in the range of source addresses extracted in step S21. That is, “source address=192.168.14.0” is detected. Step S23 detects the “Start address+1” in the range of source addresses extracted in step S21. That is, “source address=192.168.14.1” is detected. Step S24 detects the “End address” in the range of source addresses extracted in step S21. That is, “source address=192.168.14.255” is detected. Step S25 detects the “End address−1” in the range of source addresses extracted in step S21. That is, “source address=192.168.14.254” is detected.

Step S26 selects predetermined number of source addresses from sampling areas. Specifically, ten IP addresses are selected from “a range of addresses=192.168.14.2 to 192.168.14.253”.

Step S31 extracts the information set for the source port number from the specified policy information. That is, “a range of source port numbers=0 to 65535” is extracted. Steps S32 to S35 are basically the same as steps S22 to S25. Therefore, “0”, “1”, “65534”, and “65535” are detected as source port numbers to be checked. Step S36 is basically the same as step S26. Therefore, ten port numbers are selected from “port numbers=2 to 65533” as source port numbers to be checked.

Step S41 extracts the information set for the destination address from the specified policy information. Specifically, “a range of destination addresses=192.168.33.0 to 192.168.33.255” is extracted. Steps S42 to S45 are basically the same as steps S22 to S25. Therefore, “192.168.33.0 ”, “192.168.33.1”, “192.168.33.254”, and “192.168.33.255” are detected as destination addresses to be checked. Step S46 is basically the same as step S26. Therefore, ten IP addresses are selected from “a range of addresses=192.168.33.2 to 192.168.33.253” as destination addresses to be checked.

Step S51 extracts the information set for the source port number from the specified policy information. Specifically, “destination port number=80” is extracted. In this case, only one destination port number is specified and that port number itself is a singular point and no sampling area exist. Therefore, steps S52 to S56 are not performed, although steps S52 to S56 are basically the sama as steps S22 to S26.

Step S61 detects the communication protocol from the specified policy information. Here, “protocol=TCP” is detected.

Then, policy checking is performed for each combination of the source address, source port number, destination address, destination port number, and protocol extracted as described above.

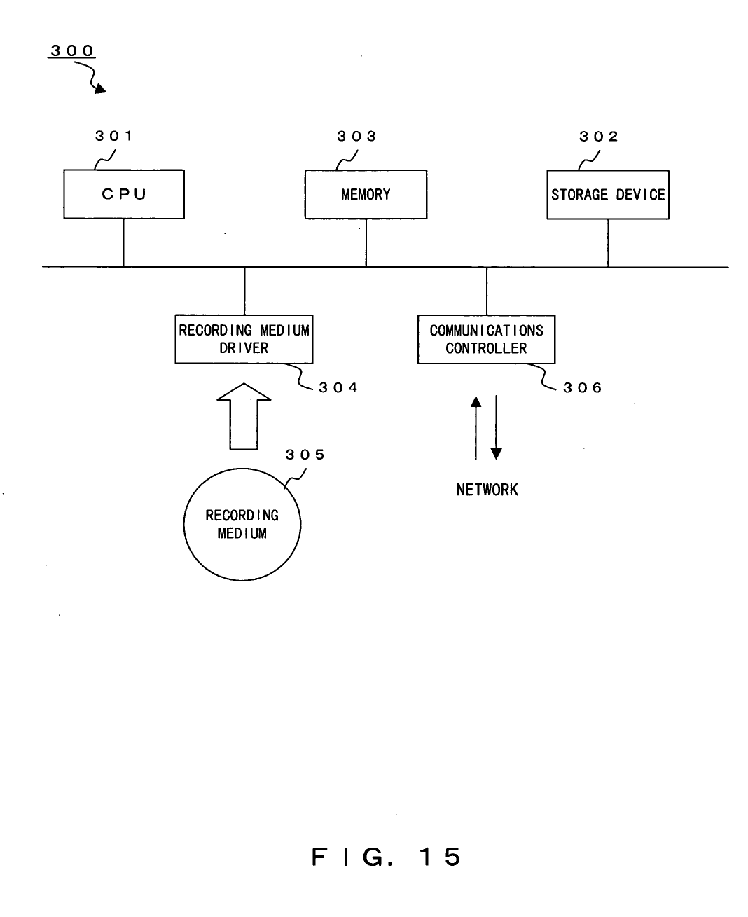

The functions provided by the policy checking device are implemented by executing on a computer a program describing the processing of the above flowchart. FIG. 15 is the block diagram of a computer 300 that executes the program.

A CPU 301 loads the program describing the processing of each flowchart from a storage device 302 to memory 303 in order to execute it. The storage device 302 is, for example, a hard disk containing the above program. The storage device 302 may be an external storage device connected to the computer 300. The memory 303 is, for example, semiconductor memory and used as the work area for the CPU 301. The network configuration information storage unit 202 and the policy information storage unit 203 shown in FIG. 5 are implemented with the storage 302 or memory 303.

A recording media driver 304 accesses a portable recording media 305 according to the instruction of the CPU 301. The portable recording media 305 includes, for example, semiconductor device (such as PC card), media to/from which information is input/output magnetically (such as flexible disk and magnetic tape), and media to/from which information is input/output optically (such as optical disk). A communication controller 306 transmits and receives data via networks according to the instruction of the CPU 301.

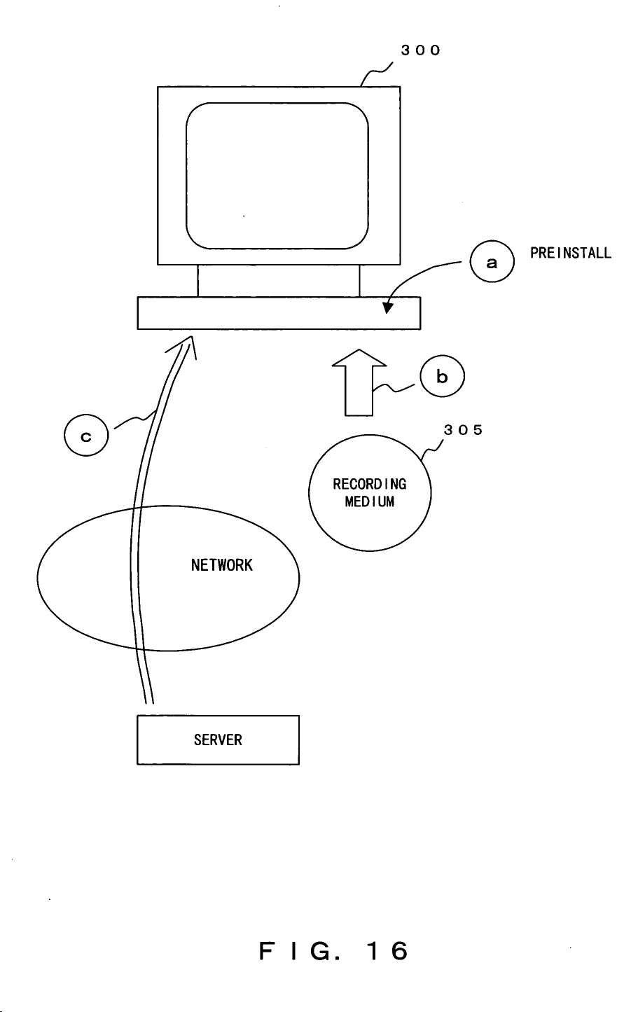

FIG. 16 is a diagram showing the installment of a program relating to the present invention. The program relating to the present invention is provided, for example, by any of the following three methods:
(1) Preinstalled in the computer. In this case, the program is, for example, preinstalled in the computer 300 before the shipment of the computer 300.
(2) Stored in the portable recording media. In this case, the program contained in the portable recording media 305 is basically installed in the storage device 302 through the recording media driver 304.
(3) Downloaded from a program server on the network. In this case, the computer 300 obtains the program by downloading from a program server. However, it is also possible to obtain the functions by executing the program on the program server without downloading the program from the server.

The foregoing invention has been described in terms of preferred embodiments. However, those skilled, in the art will recognize that many variations of such embodiments exist. Such variations are intended to be within the scope of the present invention and the appended claims.

1. A policy checking device to check whether or not a policy is properly set in a firewall device, said policy checking device comprising:
a configuration information storage unit for storing network configuration information describing a network to be managed by said firewall device;
a policy information storage unit for storing policy information describing a policy to be enforced by said firewall device;
an emulation unit for establishing a virtual network based on the network configuration information and transmitting a packet using the virtual network;
a connection unit for connecting the virtual network and said firewall device; and
a check performing unit for checking whether or not the action of said firewall device is in accordance with the policy information by monitoring the packet transmitted by said emulation unit.

2. The policy checking device according to claim 1, wherein:
said emulation unit transmits to said firewall device a packet to be allowed by said firewall device; and
said check performing unit determines that a policy is not properly set in said firewall device if the packet is not received from said firewall device.

3. The policy checking device according to claim 1, wherein:
said emulation unit transmits to said firewall device a packet to be denied by said firewall device; and
said check performing unit determines that a policy is not properly set in said firewall device if said packet is received from said firewall device.

4. The policy checking device according to claim 1, wherein:
said emulation unit transmits to said firewall device a packet to be denied by said firewall device;
said check performing unit determines that a policy is properly set in said firewall device if a packet containing a predetermined message is received from said firewall device.

5. A policy checking device to check whether or not a policy including a condition and a result is properly set in a firewall device, said policy checking device comprising:
a detection unit for detecting a singular point condition from a policy to be enforced by said firewall device;
a selection unit for selecting predetermined number of ordinary area conditions other than the singular point condition from the policy to be enforced by said firewall device; and
a verification unit for verifying whether or not results corresponding to the singular point condition and the ordinary area conditions can be obtained by said firewall device.

6. The policy checking device according to claim 5, wherein:
said detection unit detects as the singular point condition the threshold address between an address to be allowed and an address to be denied.

7. The policy checking device according to claim 5, wherein:
said detection unit detects as the singular point condition the threshold port number between a port number to be allowed and a port number to be denied.

8. The policy checking device according to claim 5, wherein:
said verification unit transmits to said firewall device packets corresponding to the singular point condition and the predetermine number of ordinary area conditions respectively, and verifies whether or not a policy is properly set in said firewall device based on the action of said firewall device that receives the packets.

9. A policy checking method for checking whether or not a policy is properly set in a firewall device, said method comprising:
obtaining network configuration information describing a network to be managed by said firewall device;
obtaining policy information describing a policy to be enforced by said firewall device;
establishing a virtual network based on the network configuration information;
transmitting a packet to said firewall device using the virtual network; and
verifying whether or not the action of said firewall device is in accordance with the policy information by monitoring the packet transmitted to said firewall device.

10. A policy checking method for checking whether or not a policy including a condition and a result is properly set in a firewall device, said policy checking method comprising:
detecting a singular point condition from a policy to be enforced by said firewall device;
selecting predetermined number of ordinary area conditions other than the singular point conditions from the policy to be enforced by said firewall device; and
verifying whether or not results corresponding to the singular point condition and the ordinary area conditions can be obtained by said firewall.

11. A computer readable medium storing a policy checking program for checking whether or not a policy is properly set in a firewall device, said program enabling a computer to perform a method:
obtaining network configuration information describing a network to be managed by said firewall device;
obtaining policy information describing a policy to be enforced by said firewall device;
establishing a virtual network based on the network configuration information;
transmitting a packet to said firewall device using the virtual network; and
verifying whether or not the action of said firewall device is in accordance with the policy information by monitoring the packet transmitted to said firewall device.

12. A computer readable medium storing a policy checking program for checking whether or not a policy including a condition and a result is properly set in a firewall device, said program enabling a computer to perform a method:
detecting a singular point condition from a policy to be enforced by said firewall device;
selecting predetermined number of ordinary area conditions other than the singular point conditions from the policy to be enforced by said firewall device; and
verifying whether or not results corresponding to the singular point condition and the ordinary area conditions can be obtained by said firewall.
